(19) United States
(12) Patent Application Publication
(10) Pub. No.: US 2007/0185623 A1
(43) Pub. Date: Aug. 9, 2007

(54) Vehicle wheel lift detection

(76) Inventors: Shih-Ken Chen, Troy, MI (US); Jihan Ryu, Sterling Heights, MI (US); Cheng-Foo Chen, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/346,948

(22) Filed: Feb. 3, 2006

(51) Int. Cl. G06F 17/00

(52) U.S. Cl. 701/1; 340/440

(57) ABSTRACT

A system and method for detecting vehicle wheel lift. The system includes wheel speed sensors for measuring the speed of each wheel of the vehicle, and suspension sensors for measuring the position of the vehicle suspension at each wheel of the vehicle. A controller determines whether any of the wheels are off the ground by using a kinematic relationship that uses the wheel speed signals and independently determines whether any of the wheels are off the ground by using damper spring displacement from the suspension sensors.

### BACKGROUND OF THE INVENTION

1. Field of the Invention

This invention relates generally to a system and method for detecting vehicle wheel lift and, more particularly, to a system and method for detecting vehicle wheel lift for roll stability purposes, where the system independently determines wheel lift using suspension displacement and wheel speed.

2. Discussion of the Related Art

Stability enhancement systems for vehicles have been offered on various vehicles for many years. Such systems typically control vehicle yaw and side-slip by controlling braking at the wheels of the vehicle. Other systems have been directed to the use of chassis systems, such as active steering and active suspension, to achieve the same objectives. Typically, these control systems do not address vehicle roll dynamics. However, for high center-of-gravity vehicles, such as SUVs, it would be desirable to control the rollover characteristics to maintain vehicle roll stability and to keep all four wheels of the vehicle on the road.

Vehicle rollover control can be achieved using differential braking control, active or semi-active suspension control, rear-wheel steering control, front-wheel steering control, or any combination thereof. In each of these control actions, the controller receives vehicle dynamic information from various vehicle sensors, such as yaw rate sensors, lateral accelerometers, roll-rate sensors, etc., and determines a proper amount of control action to be taken. A balance between controlling the vehicle roll motion and yaw motion needs to be provided to achieve the optimal vehicle response. Therefore, detection of vehicle conditions, especially roll over conditions and stability conditions, is typically viable for the quality of control. A good indication of vehicle roll stability is whether all of the wheels of the vehicle remain in contact with the road surface.

Various methodologies have been developed in the art to detect vehicle wheel lift. One technique compares vehicle lateral acceleration information with a threshold calculated from wheel speed and vehicle speed information. Another known technique for detecting wheel lift uses both passive and active systems to classify a rollover event. In this technique, wheel speed is actively changed by applying a braking torque to a certain wheel to determine if wheel lift occurs at that wheel. Since this technique relies on changing the wheel torque by application of the brakes, it may not be desirable to perform the operation during driver braking or acceleration situations.

### SUMMARY OF THE INVENTION

In accordance with the teachings of the present invention, a system and method for detecting vehicle wheel lift are disclosed. The system includes wheel speed sensors for measuring the speed of each wheel of the vehicle, and suspension sensors for measuring the position of the vehicle suspension at each wheel of the vehicle. A controller determines whether any of the wheels are off the ground by using a kinematic relationship that uses the wheel speed signals and independently determines whether any of the wheels are off the ground by using damper spring displacement from the suspension sensors.

Additional features of the present invention will become apparent from the following description and appended claims taken in conjunction with the accompanying drawings.

### BRIEF DESCRIPTION OF THE DRAWING

FIG. 1 is a schematic plan view of a vehicle system including vehicle sensors and a rollover controller;

FIG. 2 is a graph with spring extension on the horizontal axis and force on the vertical axis showing a typical force-deflection curve for a spring suspension;

FIG. 3 is a plan view of the kinematic relationships for a vehicle making a turn;

FIG. 4 is a flow chart diagram showing a process for detecting wheel lift, according to an embodiment of the present invention;

FIG. 5 is a flow chart diagram showing a process for determining wheel lift based on wheel speed signals that is part of the flow chart diagram shown in FIG. 4; and

FIG. 6 is a flow chart diagram showing a process for determining wheel lift based on damper displacement signals that is also part of the flow chart diagram shown in FIG. 4.

### DETAILED DESCRIPTION OF THE EMBODIMENTS

The following discussion of the embodiments of the invention directed to a system and method for detecting wheel lift using wheel speed signals and suspension displacement signals is merely exemplary in nature, and is in no way intended to limit the invention or its applications or uses.

The present invention proposes a system and method for detecting vehicle wheel lift that uses available vehicle sensor information, such as wheel speed, damper displacement or velocity, yaw rate, vehicle speed, steering angle and lateral acceleration, to detect the state of the vehicle wheels. The vehicle wheel states are then compared to predetermined thresholds to detect the wheel lift. Once wheel lift is detected, the information can be used in a vehicle rollover control system. By using the method of the invention to determine wheel lift, wheel braking is not required to determine wheel lift.

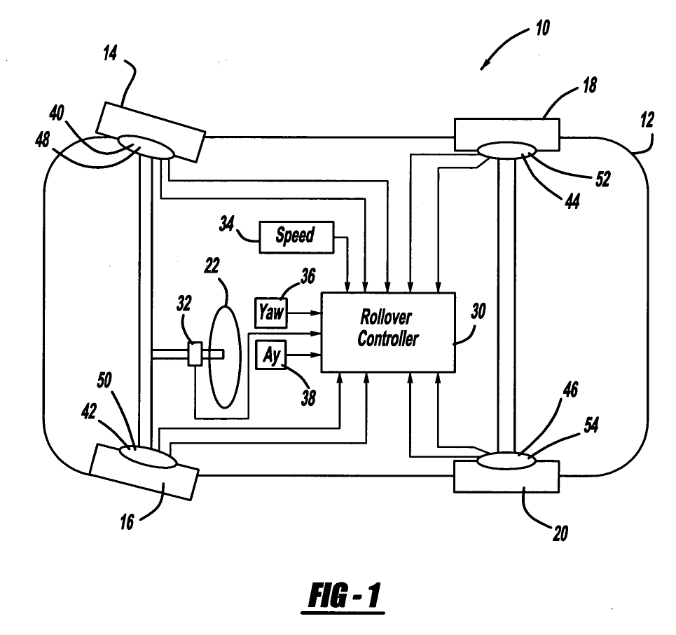

FIG. 1 is a plan view of a vehicle system 10 for a vehicle 12. The vehicle 12 includes front wheels 14 and 16 and rear wheels 18 and 20. The vehicle 12 also includes a hand-wheel 22 for steering the front wheels 14 and 16. The vehicle system 10 includes a rollover controller 30 that performs certain stability control functions, such as differential braking, active suspension control, rear-wheel steering control and/or front-wheel steering control, in response to a potential rollover condition. The rollover controller 30 includes a wheel lift detector that is used to determine the potential rollover condition, according to the invention.

The rollover controller 30 receives various input signals to provide the wheel lift detection, as will be discussed in detail below. Particularly, the vehicle system 10 includes a hand-wheel angle sensor 32 for determining the angle of the hand-wheel 22, a vehicle speed sensor 34 for providing a speed signal Vx indicative of the vehicle speed, a yaw rate sensor 36 for providing a yaw rate signal r of the vehicle yaw rate and a lateral acceleration sensor 38 for providing a lateral acceleration signal A_{y} of the lateral acceleration or side-slip of the vehicle 12.

The vehicle system 10 also includes a wheel speed sensor 40 that provides a signal V_{x,w,rf} indicative of the speed of the wheel 14, a wheel speed sensor 42 that provides a signal V_{x,w,lf} indicative of the speed of the wheel 16, a wheel speed sensor 44 that provides a signal V_{x,w,rr} indicative of the speed of the Wheel 18, and a wheel speed sensor 46 that provides a signal V_{x,w,lr} indicative of the speed of the wheel 20. The vehicle system 10 further includes a damper sensor 48 that provides a signal δ indicative of the suspension damper displacement of the suspension damper at the wheel 14, a damper sensor 50 that provides a signal δ indicative of the suspension damper displacement at the wheel 16, a damper sensor 52 that provides a signal δ indicative of the suspension damper displacement at the wheel 18 and a damper sensor 54 that provides a signal δ indicative of the suspension damper displacement at the wheel 20.

As will be discussed in detail below, the wheel lift is detected in two ways, particularly, based on damper displacement and wheel speed. For the damper displacement method, FIG. 2 shows a typical spring force-deflection curve for a vehicle suspension. Before any wheel of the vehicle 12 will lift off the ground, the suspension damper at that wheel will be in expansion. As the suspension damper expands, the force on the suspension damper decreases until it reaches a rebound bumper at point 58. At this point, the displacement of the damper is at a critical displacement δ_{cr}. The damper spring exhibits a near linear relationship between the force and its deflection until it reaches the rebound bumper. When the damper spring hits the rebound bumper, the spring force quickly decreases to zero. At this point, the wheel starts to lift off the ground.

Equation (1) below can be used to determine whether this condition has occurred by determining if the difference between the displacement signal δ and the critical displacement point δ_{cr} is less than a predetermined threshold Δδ_{threshold} at each wheel. Particularly, as the displacement of the suspension damper increases as the vehicle begins to roll, the displacement signal δ increases and approaches the critical displacement point δ_{cr}. When the difference between the displacement signal δ and the critical displacement point δ_{cr} is small enough, a wheel lift condition is imminent. An example of a critical deflection value for a typical SUV is 60 mm for the front of the vehicle and 100 mm for the rear of the vehicle. These critical deflection values are part of a suspension design parameter and can be easily measured. A typical critical threshold Δδ_{threshold} can be 10 mm.
abs(δ−δ_{cr})<Δδ_{threshold} (1)
If the difference between the displacement signal δ and the critical displacement point δ_{cr} is less than the predetermined threshold Δδ_{threshold} then that wheel has lifted off the ground.

In this embodiment, the suspension damper sensors are displacement sensors. However, damper velocity sensors can also be used in the same manner to indicate a potential wheel lift.

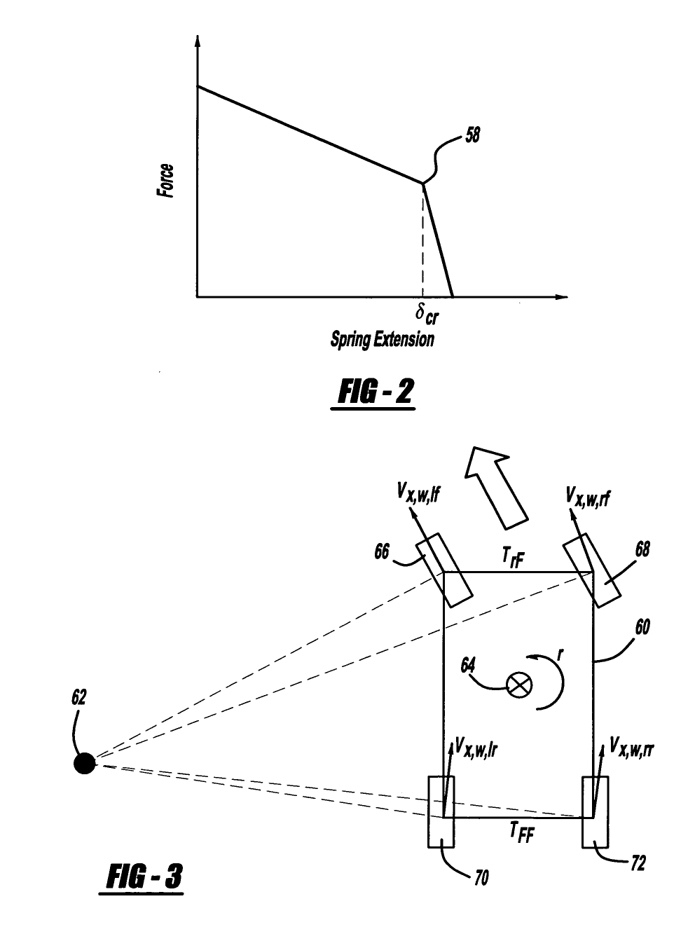

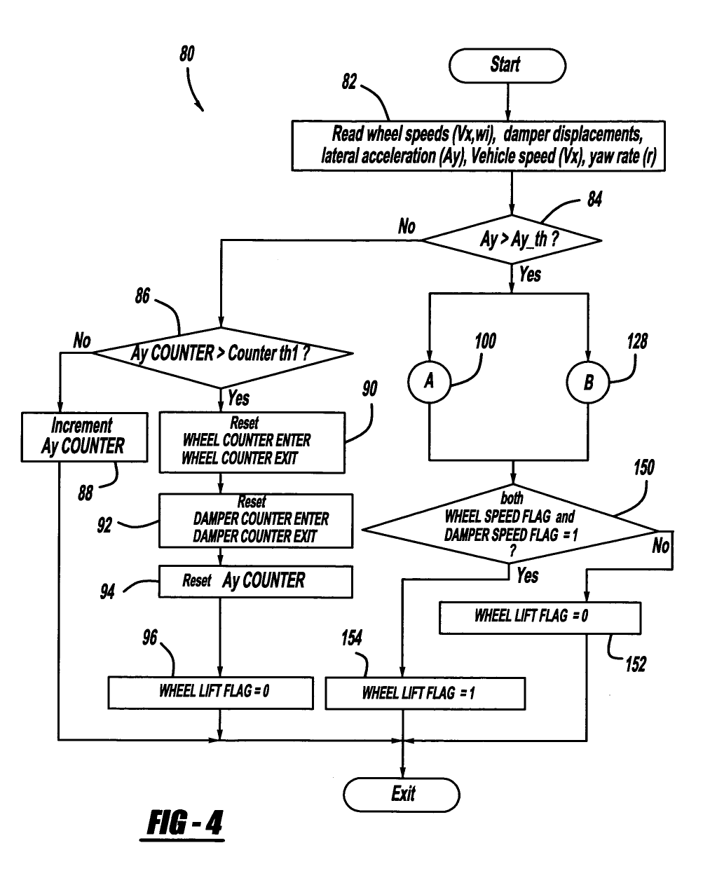

FIG. 3 is a diagram of a vehicle 60 making a turn around a turn center 62. Based on the kinematic relationships shown by this diagram, potential wheel lift can be detected. This relationship will use the vehicle speed signal Vₓ, the left front wheel speed signal V_{x,w,lf} of the speed of the left front wheel 66, the right front wheel speed signal V_{x,w,lf} of the speed of the right front wheel 68, the left rear wheel speed signal V_{x,w,lr} of the speed of the left rear wheel 70 and the right rear wheel speed signal V_{x,w,rr} of the speed of the rear right wheel 72. Also, the kinematic relationship uses the track distance T_{rf} between the front wheels 66 and 68 and the track distance Tᵣᵣ between the rear wheels 70 and 72. The kinematic relationship also uses the yaw rate signal r around the center-of-gravity 64 of the vehicle 60.

From these values and under normal driving condition with no wheel lift, the kinematic relationship between the wheels can be described by equations (2) and (3) below.
rT_{rf}≈V_{x,w,rf}−V_{x,w,lf} (2)
rTᵣᵣ≈V_{x,w,rr}−V_{x,w,lr} (3)
This relationship can also be used to determine wheel lift if the difference between the expressions in both equations (2) and (3) is greater than a predetermined threshold ΔV_{threshold} as provided by equations (4) and (5) below.
abs[rT_{rf}−(V_{x,w,rf}−V_{x,w,lf})]>ΔV_{threshold} (4)
abs[rTᵣᵣ−(V_{x,w,rr}−V_{x,w,lr})]>ΔV_{threshold} (5)
In one example, for a typical full size SUV, the threshold ΔV_{threshold} can be 1.0 kph if the vehicle is braking or coasting and 3.0 kph if the vehicle is accelerating.

FIG. 4 is a flow chart diagram 80 showing a process for determining wheel lift, according to an embodiment of the present invention. The algorithm in the controller 30 first reads the wheel speed signals V_{x,wi}, the damper displacement signals δ, the lateral acceleration signal A_{y}, the vehicle speed signal Vₓ and the vehicle yaw rate signal r at box 82. The algorithm then determines whether the lateral acceleration signal A_{y} is greater than a predetermined lateral acceleration threshold A_{y}_{_{—}}ₜₕ at decision diamond 84. The algorithm only determines potential wheel lift when the vehicle is cornering.

If the vehicle is not cornering where the lateral acceleration signal A_{y} is below the threshold A_{y}_{_{—}}ₜₕ, then the algorithm determines whether a lateral acceleration counter has reached a first predetermined counter threshold at decision diamond 86. For normal driving where the lateral acceleration signal A_{y} is less than the lateral acceleration threshold A_{y}_{_{—}}ₜₕ at the decision diamond 84, previous wheel lift detection loops of the algorithm may have indicated that there is a previous wheel lift where a WHEEL LIFT FLAG has been set to 1. The algorithm does not want to immediately go to a no wheel lift condition until some period of time thereafter. Thus, it is possible that the lateral acceleration A_{y} will be below the threshold A_{y}_{_{—}}ₜₕ, but the vehicle is just coming out of a turn where wheel lift was possibly detected. Therefore, the algorithm uses the lateral acceleration counter to provide a predetermined time after a possible wheel lift detection to change the WHEEL LIFT FLAG to 0 indicating no wheel lift. If the lateral acceleration counter is not greater than the first counter threshold at the decision diamond 89, the algorithm will increment the lateral acceleration counter at box 88 and exit the algorithm for the next loop, where the WHEEL LIFT FLAG may still be set to 1.

If, however, the lateral acceleration signal A_{y} is less than the lateral acceleration threshold A_{y}_{_{—}}ₜₕ at the decision diamond 84 and the lateral acceleration counter is greater than the first counter threshold at the decision diamond 86, meaning that the lateral acceleration signal A_{y} has been below the threshold A_{y}_{_{—}}ₜₕ for a long enough period of time, the algorithm will reset a WHEEL COUNTER ENTER and a WHEEL COUNTER EXIT at box 90, reset a DAMPER COUNTER ENTER and a DAMPER COUNTER EXIT at box 92 and reset the lateral acceleration counter at box 94. It may be that the wheel counters and the damper counters were already at zero, but they could have been advanced, as will be discussed in more detail below. The algorithm then sets the WHEEL LIFT FLAG to 0 at box 96 indicating no wheel lift.

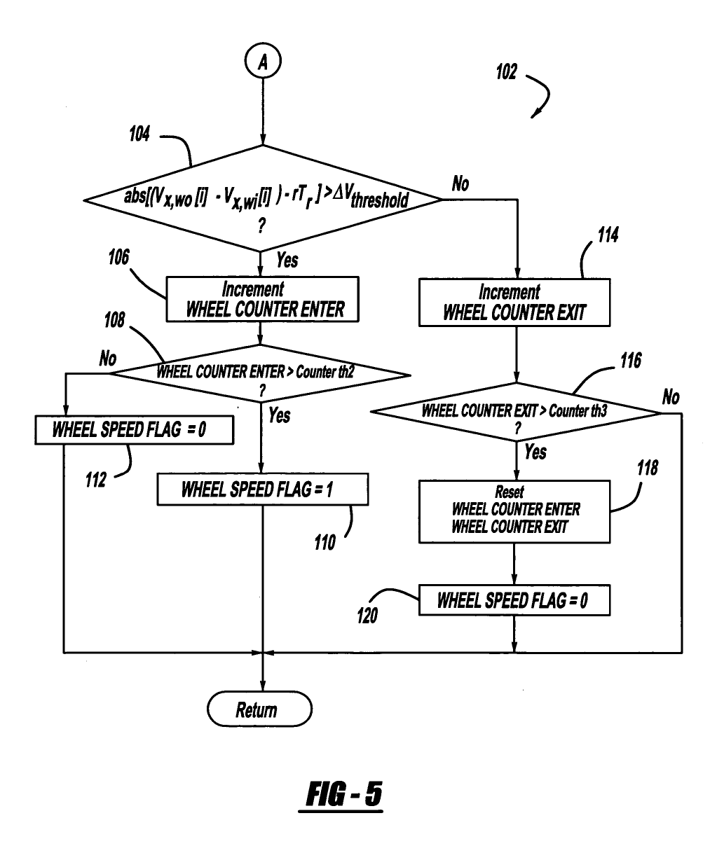

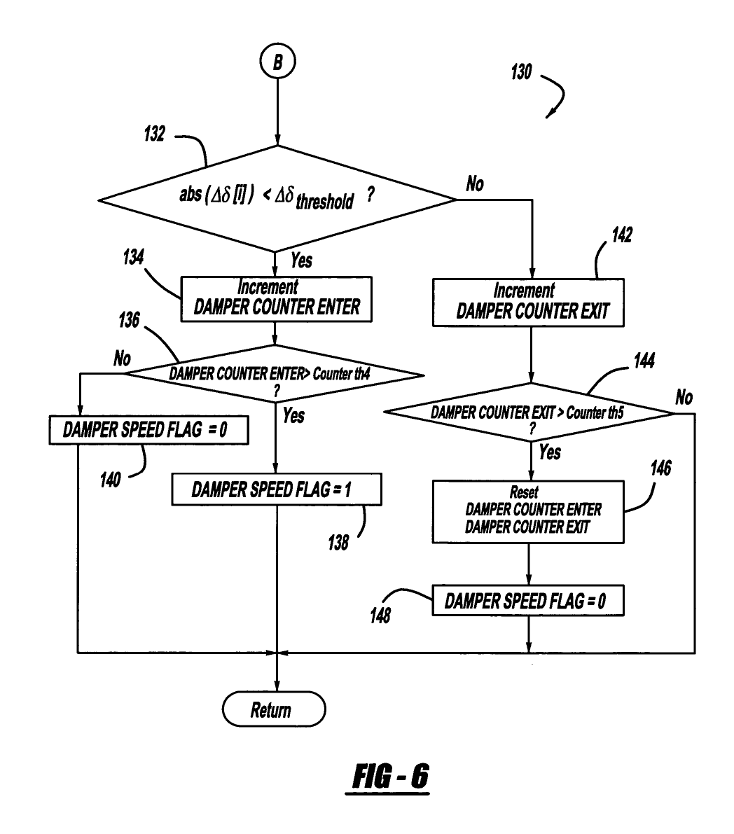

If the algorithm determines that the lateral acceleration signal A_{y} is greater than the lateral acceleration threshold A_{y}_{_{—th}} at the decision diamond 84, then the algorithm will simultaneously determine if wheel lift is detected using both the damper displacement method and the wheel speed method, as discussed above. Particularly, at circle 100, the wheel speed algorithm will determine whether wheel lift is detected using the wheel speed signals. FIG. 5 is a flow chart diagram 102 showing this process. The wheel speed algorithm will determine whether either of the kinematic relationships provided by equations (2) and (3) are greater than the threshold ΔV_{threshold} per equations (4) and (5) at decision diamond 104. Particularly, the wheel speed algorithm calculates the difference between the speed of the outside wheel and the speed of the inside wheel and compares the difference to the product of the yaw rate and the vehicle track width to see if it is greater than the threshold ΔV_{threshold}, where the threshold is a function of vehicle longitudinal acceleration. The vehicle longitudinal acceleration can be obtained either from the power train or by the differentiation of the wheel speed signals.

If either of the expressions in equations (4) and (5) is met, then at least one of the wheels is potentially off the ground. The wheel speed algorithm will then increment the WHEEL COUNTER ENTER at box 106. The WHEEL COUNTER ENTER is used so that the wheel speed algorithm does not immediately indicate wheel lift has occurred if equation (4) or (5) is satisfied reducing the chance of a false positive. The wheel speed algorithm must go through several loops of getting the same result that wheel lift is detected before it will output a WHEEL SPEED FLAG of 1, indicating wheel lift is present by the wheel speed method. The specific time frame from when the wheel lift is first detected and when it is output from the wheel speed algorithm is application specific for different vehicles, and would be determined by testing and simulations.

The wheel speed algorithm then determines whether the WHEEL COUNTER ENTER is greater than a second counter threshold at decision diamond 108. If the WHEEL COUNTER ENTER is greater than the second counter threshold at the decision diamond 108, then the wheel speed algorithm sets the wheel speed flag to 1 at box 110 indicating that the wheel speed algorithm has detected a wheel lift. As will be discussed in more detail below, both of the wheel lift detection approaches must indicate a wheel lift before the wheel speed algorithm outputs a WHEEL LIFT FLAG of 1 indicating a wheel lift. If the WHEEL COUNTER ENTER is not greater than the second counter threshold at decision diamond 108, the wheel speed algorithm maintains the WHEEL SPEED FLAG set to 0 at box 112.

If neither of the equations (4) and (5) are met at the decision diamond 104, then the wheel speed algorithm increments the WHEEL COUNTER EXIT at box 114. The same principal applies for exiting the wheel lift detection as for entering the wheel lift detection. In particular, if a previous wheel lift has been detected using the wheel speed signals, the wheel speed algorithm does not want to remove that indication until a suitable period of time has passed. The wheel speed algorithm then determines whether the WHEEL COUNTER EXIT is greater than a third counter threshold at decision diamond 116. If the WHEEL COUNTER EXIT is not greater than the third counter threshold at the decision diamond 116, then the wheel speed algorithm returns to the flow chart diagram 80 by maintaining the WHEEL SPEED FLAG still set to 1. If the WHEEL COUNTER EXIT is greater than the third counter threshold at the decision diamond 116, then the wheel speed algorithm resets the WHEEL COUNTER ENTER and the WHEEL COUNTER EXIT to 0 at box 118. The wheel speed algorithm then sets the WHEEL SPEED FLAG to 0, indicating no wheel lift from the wheel speed detection process at box 120. The wheel speed algorithm then returns to the flow chart diagram 80.

The algorithm is simultaneously determining whether there is wheel lift based on the damper displacement method, as discussed above, at circle 128. FIG. 6 is a flow chart diagram 130 showing this process, which is similar to the process of the flow chart diagram 102. Particularly, the damper algorithm determines whether the difference between the displacement signal δ and the critical displacement point δ_{cr} for all of the wheels is below the threshold Δδ_{threshold} as provided by equation (1) at decision diamond 132. If the difference between the displacement signal δ and the critical displacement point δ_{cr} for any of the wheels is below the threshold Δδ_{threshold} at the decision diamond 132, then the damper algorithm increments the DAMPER COUNTER ENTER at box 134 so that it does not give a wheel lift detection too quickly, as discussed above. The algorithm then determines whether the DAMPER COUNTER ENTER is greater than a fourth counter threshold at decision diamond 136. If the DAMPER COUNTER ENTER is greater than the fourth counter threshold at the decision diamond 136, then the algorithm sets a DAMPER SPEED FLAG to 1 at box 138 indicating that wheel lift has been detected by the suspension sensors. Otherwise, the damper algorithm maintains the DAMPER SPEED FLAG at 0 at box 140.

If the measured damper displacement signal δ is greater than the threshold Δδ_{threshold} at the decision diamond 132, then the damper algorithm increments a DAMPER COUNTER EXIT at box 142. The damper algorithm then determines whether the DAMPER COUNTER EXIT is greater than a fifth counter threshold at decision diamond 144. If the DAMPER COUNTER EXIT is not greater than the fifth counter threshold at the decision diamond 144, then the damper algorithm maintains the DAMPER SPEED FLAG set to 1. If the DAMPER COUNTER EXIT is greater than the fifth counter threshold at the decision diamond 144, then the damper algorithm resets the DAMPER COUNTER ENTER and the DAMPER COUNTER EXIT to 0 at box 146 and sets the DAMPER SPEED FLAG to 0 at box 148. The damper algorithm then returns to the flow chart diagram 80.

The algorithm determines whether both of the WHEEL SPEED FLAG and the DAMPER SPEED FLAG are set to 1 at decision diamond 150. If neither of the WHEEL SPEED FLAG and the DAMPER SPEED FLAG is set to 1, or only one of the WHEEL SPEED FLAG or the DAMPER SPEED FLAG is set to 1, then the algorithm sets the WHEEL LIFT FLAG to 0 at box 152 indicating no wheel lift. If however, both the WHEEL SPEED FLAG and the DAMPER SPEED FLAG are set to 1 at the decision diamond 150, then the algorithm sets the WHEEL LIFT FLAG to 1, indicating a wheel lift, at box 154.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for detecting if a wheel of a vehicle has lifted off of the ground, said system comprising:
a separate wheel speed sensor for determining the speed of each wheel of the vehicle, each of the wheel speed sensors providing a wheel speed signal;
a plurality of suspension sensors for measuring a position of a vehicle suspension at each of the wheels of the vehicle, each of the suspension sensors providing a suspension signal; and
a controller responsive to the wheel speed signals and the suspension signals, said controller determining whether any of the wheels are off of the ground by using the wheel signals or the suspension signals.

2. The system according to claim 1 wherein the suspension sensors are displacement sensors.

3. The system according to claim 1 wherein the suspension sensors are velocity sensors.

4. The system according to claim 1 further comprising a lateral acceleration sensor for providing a lateral acceleration signal of the lateral acceleration of the vehicle, wherein the controller only determines whether wheel lift is occurring if the lateral acceleration of the vehicle is above a predetermined lateral acceleration threshold.

5. The system according to claim 1 further comprising a yaw rate sensor for measuring the yaw rate of the vehicle, wherein the controller determines if the wheel speed signals indicate wheel lift by the equation:
abs[rT−(V_{x,w,r}−V_{x,w,l})]>ΔV_{threshold}
where r is the yaw rate signal, T is the track distance between opposing wheels of the vehicle, V_{x,w,r} is the wheel speed signal for a right wheel of the vehicle, V_{x,w,l} is the wheel speed signal for an opposing left wheel of the vehicle and ΔV_{threshold} is a wheel speed threshold, and wherein if the equation expression is greater than the threshold, then wheel lift may be occurring.

6. The system according to claim 1 wherein the controller determines if the suspension signals indicate wheel lift for each of the wheels by the equation:
abs(δ−δ_{cr})<Δδ_{threshold}
where δ is the suspension displacement for one of the suspension sensors, δ_{cr} is a critical displacement where the suspension hits a rebound bumper and Δδ_{threshold} is a predetermined threshold, and wherein if the equation expression is less than the threshold, then wheel lift may be occurring.

7. The system according to claim 1 wherein the controller indicates that wheel lift is occurring only if the controller determines that wheel lift is occurring using both the wheel speed signals and the suspension sensors.

8. The system according to claim 1 wherein the controller uses counters to set predetermined times when the controller will indicate wheel lift and not indicate wheel lift.

9. The system according to claim 1 wherein the system is part of a rollover stability control system.

10. A system for detecting if a wheel of a vehicle has lifted off of the ground, said system comprising:
a lateral acceleration sensor for measuring the lateral acceleration of the vehicle and providing a lateral acceleration signal;
a yaw rate sensor for measuring the yaw rate of the vehicle and providing a yaw rate signal;
a separate wheel speed sensor for determining the speed of each wheel of the vehicle, each of the wheel speed sensors providing a wheel speed signal;
a plurality of suspension displacement sensors for measuring the displacement of a vehicle suspension at each of the wheels, each of the suspension displacement sensors providing a suspension displacement signal; and
a controller responsive to the lateral acceleration signal, the yaw rate signal, the wheel speed signals and the suspension signals, said controller using a kinematic relationship including the yaw rate signal, the wheel speed signals and a track distance between opposing right and left wheels to provide an indication of whether wheel lift is occurring, said controller further determining if any of the wheels are off of the ground by determining if the suspension signal at any of the wheels is close enough to a predetermined critical suspension position, wherein the controller only determines if wheel lift is occurring if the lateral acceleration signal is greater than a predetermined threshold.

11. The system according to claim 10 wherein the controller only indicates wheel lift is occurring when both the kinematic relationship and the suspension signals indicate a wheel lift is occurring.

12. The system according to claim 1 wherein the controller determines if the kinematic relationship indicates wheel lift by the equation:
abs[rT−(V_{x,w,r}−V_{x,w,l})]>ΔV_{threshold}
where r is the yaw rate signal, T is the track distance between opposing wheels of the vehicle, V_{x,w,r} is the wheel speed signal for a right wheel of the vehicle, V_{x,w,l} is the wheel speed signal for an opposing left wheel of the vehicle and ΔV_{threshold} is a wheel speed threshold, and wherein if the equation expression is greater than the threshold, then wheel lift may be occurring.

13. The system according to claim 1 wherein the controller determines if the suspension signals indicate wheel lift for each of the wheels by the equation:
abs(δ−δ_{cr})<Δδ_{threshold}
where δ is the suspension displacement for one of the suspension sensors, δ_{cr} is a critical displacement where the suspension hits a rebound bumper and Δδ_{threshold} is a predetermined threshold, and wherein if the equation expression is less than the threshold, then wheel lift may be occurring.

14. The system according to claim 10 wherein the controller uses counters to set predetermined times when the controller will indicate wheel lift and not indicate wheel lift.

15. A method for determining if a wheel of a vehicle has lifted off of the ground, said method comprising:
determining the speed of each wheel of the vehicle;
determining the position of a vehicle suspension at each wheel of the vehicle;
determining that a potential wheel lift condition exists for any of the wheels using a kinematic relationship based on wheel speed; and
determining that a potential wheel lift is occurring based on how close the suspension position of any of the vehicle suspensions is to a critical position.

16. The method according to claim 15 wherein determining that a potential wheel lift condition exists is done only if the lateral acceleration of the vehicle is greater than a predetermined lateral acceleration.

17. The method according to claim 15 wherein the method only determines wheel lift is occurring if both the kinematic relationship and the suspension position indicate wheel lift.

18. The method according to claim 15 further comprising measuring the yaw rate of the vehicle, wherein determining that a potential wheel lift condition exists for any of the wheels using a kinematic relationship includes using the equation:
abs[rT−(V_{x,w,r}−V_{x,w,l})]>ΔV_{theshold}
where r is the yaw rate signal, T is the track distance between opposing wheels of the vehicle, V_{x,w,r} is the wheel speed signal for a right wheel of the vehicle, V_{x,w,l} is the wheel speed signal for an opposing left wheel of the vehicle and ΔV_{threshold} is a wheel speed threshold, and wherein if the equation expression is greater than the threshold, then wheel lift may be occurring.

19. The method according to claim 15 wherein determining that a potential wheel lift is occurring based on how close the suspension position of any of the vehicle suspensions is to a critical position includes using the equation:
abs(δ−δ_{cr})<Δδ_{threshold}
where δ is the suspension displacement for one of the suspension sensors, δ_{cr} is a critical displacement where the suspension hits a rebound bumper and Δδ_{threshold} is a predetermined threshold, wherein wheel lift may be occurring if the expression is less than the threshold.

20. The method according to claim 15 further comprising using counters to set predetermined times when wheel lift will be indicated and will not be indicated.
